(19) United States
(12) Patent Application Publication
(10) Pub. No.: US 2024/0025097 A1
(43) Pub. Date: Jan. 25, 2024

(54) INJECTION MOLD, TRANSPARENT PLASTIC PART AND INJECTION MOLDING METHOD

(71) Applicant: SHENZHEN ZHONGFUNENG ELECTRIC EQUIPMENT CO., LTD, Shenzhen (CN)

(72) Inventors: Baiping DING, Shenzhen (CN); Feng YANG, Shenzhen (CN); Yangbiao HUANG, Shenzhen (CN); Xingjun LIU, Shenzhen (CN); Ruixia ZHUANG, Shenzhen (CN); Peixuan YIN, Shenzhen (CN); Zheng GONG, Shenzhen (CN)

(73) Assignee: SHENZHEN ZHONGFUNENG ELECTRIC EQUIPMENT CO., LTD, Shenzhen (CN)

(21) Appl. No.: 17/870,908

(22) Filed: Jul. 22, 2022

(51) Int. Cl. B29C 45/44; B29C 45/26; B29C 45/33

(52) U.S. Cl. CPC B29C 45/4421; B29C 45/4435; B29C 45/2602; B29C 45/33

(57) ABSTRACT

An injection mold, including: an insert, a fixed half, a moving half and a core. The fixed half has a first groove and a rubber inlet communicating with the first groove. The moving half is configured for matching with the fixed half, the moving half has a second groove, and the fixed half and the moving half are arranged in layers to form a cavity together by the first groove communicating with the second groove. The core is partially embedded in the second groove and connected to the movable mold, the core has a diameter variable end at least partially located in the cavity. The insert is arranged on an end face of the diameter variable end, a first molding section is formed between the insert and a bottom of the first groove, the first molding section is configured for injection molding the flat portion.

### BACKGROUND

### Technical Field

The present application relates to the field of mold technology, and more specifically, relates to injection mold, transparent plastic part and injection molding method.

### Description of the Related Art

Mold contains various tools used in industrial production to obtain the desired products by injection molding, blow molding, extrusion, die casting or forging molding, smelting, stamping, etc., and is widely used in blanking, die forging, cold heading, extrusion, powder metallurgy parts pressing, pressure casting, and compression molding or injection molding of engineering plastics, rubber, ceramics and other products. Mold has a specific shape of its contour or cavity. Using the cutting edge in the contour shape can separate the blank according to the contour shape, which also known as blanking die. A corresponding three-dimensional shape is obtained via the specific cavity shape. The mold generally includes two parts, moving half and fixed half (or punch and die), which can be divided and combined. When the parts are separated, the parts are taken out, and the blanks are injected into the cavity of the mold when they are closed.

After the injection molding process of the mold is completed, a demolding action is required, and the demolding process of the mold is generally realized by an ejector mechanism. For the transparent plastic part with the inner undercut, due to the existence of the inner undercut, it is difficult to push out the mold during the demolding process, so it is often manufactured by separately injection molding and subsequent assembling. If one-piece injection molding is used, the ejector mechanism needs to avoid the inner undercut, and a multi-lobe retractable structure is often used. For the multi-lobe retractable ejector mechanism, due to the gap between the single lobes, the produced transparent plastic part will have the problem of welding line.

### SUMMARY

The purpose of the embodiments of the present application is to provide an injection mold, a transparent plastic part, and an injection molding method, so as to solve the technical problem that the transparent plastic part with the inner undercut in the prior art has a welding line during integral injection molding.

To achieve the above purpose, the technical scheme adopted in the application is as follows:

An injection mold, configured for injection molding a transparent plastic part and including an undercut portion and a flat portion connected to the undercut portion, is provided. The injection mold includes an insert, a fixed half, a moving half and a core. The fixed half has a first groove and a rubber inlet communicating with the first groove. The moving half configured for matching with the fixed half, the moving half has a second groove, and the fixed half and the moving half are arranged in layers to form a cavity together by the first groove communicating with the second groove. The core is partially embedded in the second groove and connected to the movable mold, the core has a diameter variable end at least partially located in the cavity, the diameter of the diameter variable end is variable, and the insert is arranged on the end face of the diameter variable end, a first molding section is formed between the insert and a bottom of the first groove, the first molding section is used for injection molding the flat portion; a second molding section is formed between an outer wall of the diameter variable end and a cavity wall of the corresponding cavity, the second molding section is configured for injection molding the undercut portion; the first molding section communicates with the second molding section to integrally form the flat portion and the undercut portion.

In some embodiments, the injection mold further includes a demolding component, the demolding component is connected to the core, and the demolding component is connected to the core, the demolding component is configured to reduce the diameter of the diameter variable end to separate the outer sidewall of the diameter variable end from the inner sidewall of the undercut portion.

In some embodiments, a cross-sectional shape of the diameter variable end is a circle, and the outer wall of the diameter variable end is provided with an outer undercut to form an inner undercut on the inner side wall of the undercut portion.

In some embodiments, the core comprises a first slide and a second slide, and a plurality of the first slides are circumferentially arranged at intervals and a second slide is arranged between any two adjacent first slides, and the outer sidewall of each first slide and the outer sidewall of each second slides are arc-shaped walls, and each of the first slides and each of the second slides are enclosed to form the diameter variable end, the inner sidewall of the first slide and the inner side wall of each of the second slides are enclosed to form an accommodating space; the demolding component includes a telescopic cone, the telescopic cone is arranged in the accommodating space and slides along the axial direction of the core, the telescopic cone slides along the axis of the core in a direction away from the fixed half, each of the first slides and each of the second slides are driven to radially and inwardly retract synchronously along the core to separate the outer wall of the diameter variable end from the inner sidewall of the undercut portion.

In some embodiments, the first slide and the second slide are both provided with locating slots arranged along the axial direction of the core, the position of the telescopic cone corresponding to each of the locating slots are respectively provided with a limit block slidably connected to the corresponding locating slots.

In some embodiments, a first included angle is formed between the first slide and a center line of the telescopic cone, and a second included angle is formed between the second slide and the center line of the telescopic cone, and the first included angle is twice the second included angle.

In some embodiments, a surface of the insert facing the fixed half is a smooth plane to form the flat portion with a flat inner surface between the inner bottom surface of the first groove and the insert.

Another purpose of the present application is to provide a transparent plastic part, integral injection molded by the injection mold and the transparent plastic part includes an undercut portion and a flat portion integrally formed with the undercut portion, a groove is formed in the undercut portion, and an inner bottom surface of the groove forms the flat portion.

Another purpose of the present application is to provide a method of injection molding, including the steps of:
S1: preparing the injection mold;
S2: injecting, melting transparent molding material, and injecting the molten molding material into the first molding section and the second molding section through the glue inlet;
S3: holding pressure, maintaining the fixed half and the moving half for a predetermined time to integrally form the undercut portion and the flat portion;
S4: demolding, separating the fixed half and the movable mold, and taking out the undercut portion and the flat portion.

In some embodiments, the demolding includes the steps of:
S41: the telescopic core slides a predetermined distance along the central axis of the core and away from the direction of the fixed half;
S42: each of the first slides and each of the second slides are inwardly retracted along the radial direction of the core under a driving of the telescopic cone;
S43: the outer wall of the diameter variable end is separated from the undercut portion.

The above one or more technical solutions in the injection mold provided by the present application have at least one of the following technical effects: the first molding section and the second molding section of the injection mold are filled with transparent and molten molding materials, the undercut portion and flat portion of the transparent plastic part are formed. Since the diameter variable end in this embodiment can extend into the cavity in the direction of the fixed half, part of the transparent molding material in the first molding section and the second molding section is shaped, and the entire surface of the insert abuts against the flat portion, so that the occurrence of clamping lines on the flat portion can be avoided. In this way, the undercut portion and the flat portion can be integrally injection-molded by using the injection mold in this application, and there is no need to assemble the flat portion on the undercut portion. Production and assembly efficiency of the transparent plastic part could be improved, and clamping lines of in the flat portion could be avoided.

### BRIEF DESCRIPTION OF THE DRAWINGS

In order to illustrate the technical solutions in the embodiments of the present application more clearly, the following briefly introduces the accompanying drawings that need to be used in the description of the embodiments or the prior art. Obviously, the drawings in the following description are only for the present application. In some embodiments, for those of ordinary skill in the art, other drawings can also be obtained according to these drawings without any creative effort.

FIG. 1 is a perspective view of an injection mold provided by an example of the present application;

FIG. 2 is a cross-sectional view of the injection mold shown in FIG. 1;

FIG. 3 is a partial cross-sectional view of the cavity of FIG. 1 not filled with molding material;

FIG. 4 is an exploded view of the injection mold shown in FIG. 1;

FIG. 5 is a schematic diagram of a telescopic cone provided by an example of the present application;

FIG. 6 is a schematic diagram of an undercut portion provided by an example of the present application;

FIG. 7 is a schematic diagram of a miner lamp provided by an example of the present application.

Reference numbers in the figures are as following:
1—transparent plastic part; 101—undercut portion; 102—groove; 103—flat portion; 104—annular boss;
2—fixed half; 201—first installation seat; 202—first installation position; 203—first mold core;
3—movable mold; 301—second installation seat; 302—second installation position; 303—second mold core; 304—installation cavity; 305—third installation position; 306—limiter; 311—first molding section; 312—second molding section;
4—cavity; 401—first groove; 402—second groove; 403—annular groove;
5—core; 501—first slide; 502—second slide; 503—accommodating space; 504—locating slot; 505—diameter variable end;
6—demolding component; 601—telescopic cone; 6011—position limiting block; 602—first connector; 603—through hole;
7—insert; 701—rod;
8—ejection component;
9—lamp housing; 901—lamp cover; 902—light-emitting lens;
10—drive assembly; 1001—first connection board;
11—second connection board;
12—second connector; and
13—locking component.

### DETAILED DESCRIPTION OF THE EMBODIMENTS

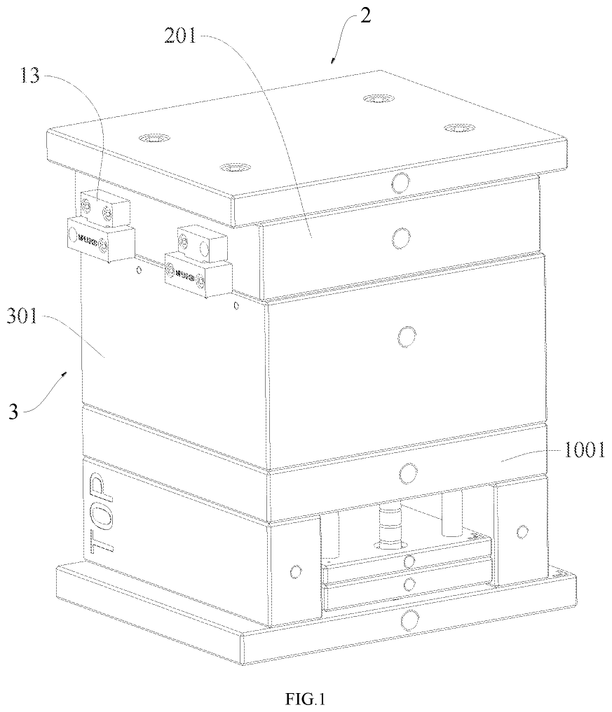

In order to make the technical problems, technical solutions and beneficial effects to be solved by the present application clear, the present application will be described in further detail below with reference to FIGS. 1 to 7. It should be understood that the specific embodiments described herein are only used to explain the present application, but not to limit the present application.

It should be noted that when an element is referred to as being “fixed to” or “disposed on” another element, it can be directly on the other element or indirectly on the other element. When an element is referred to as being “connected to” another element, it can be directly connected to the other element or indirectly connected to the other element.

It is to be understood that the terms of “length”, “width”, “upper”, “lower”, “front”, “rear”, “left”, “right”, “vertical”, “horizontal”, “top”, “bottom”, “inside”, “outside”, etc. indicate the orientation or positional relationship based on the orientation or positional relationship shown in the accompanying drawings, only for the convenience of describing the application and simplifying the description, rather than indicating or implying that the device or element must have a particular orientation, be constructed and operate in a particular orientation, and therefore should not be construed as a limitation of the present application.

In addition, the terms of “first” and “second” are only used for descriptive purposes, and should not be construed as indicating or implying relative importance or implying the number of indicated technical features. Features delimited with “first” and “second” may expressly or implicitly include one or more of the features. In the description of the present application, “a plurality of” means two or more, unless otherwise expressly and specifically defined.

Reference in this specification to “one example,” “some examples,” or “an example” means that a particular feature, structure, or characteristic described in connection with the example is included in one or more examples of the application. The appearances of the phrases “in one example,” “in some examples,” “in other examples,” “in other examples,” etc. in various places in this specification are not necessarily all referring to the same examples, but means “one or more, but not all, examples” unless otherwise specifically emphasized. Furthermore, the particular features, structures or characteristics may be combined in any suitable manner in one or more examples.

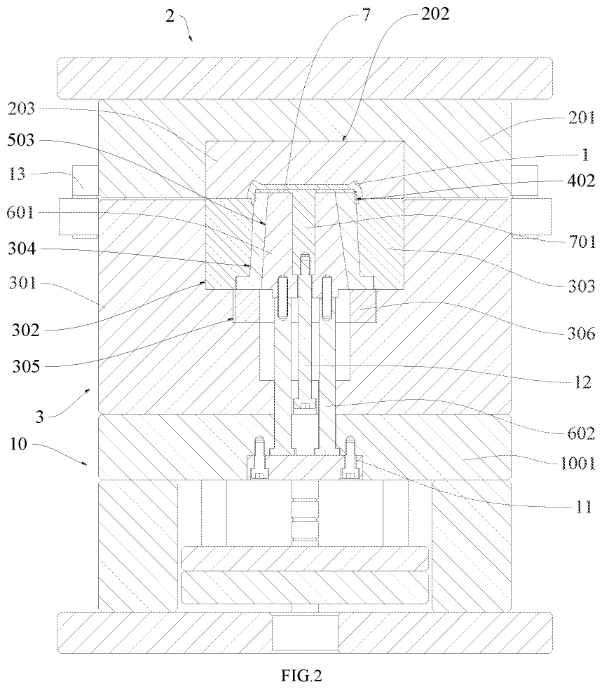

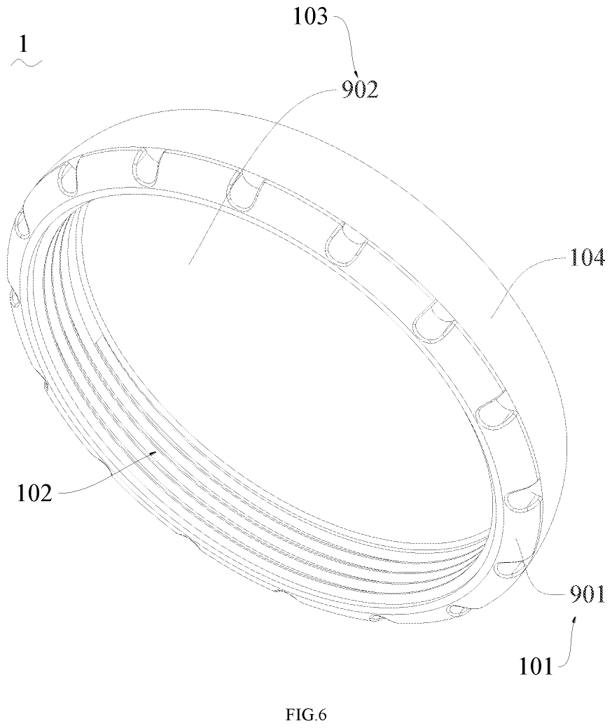

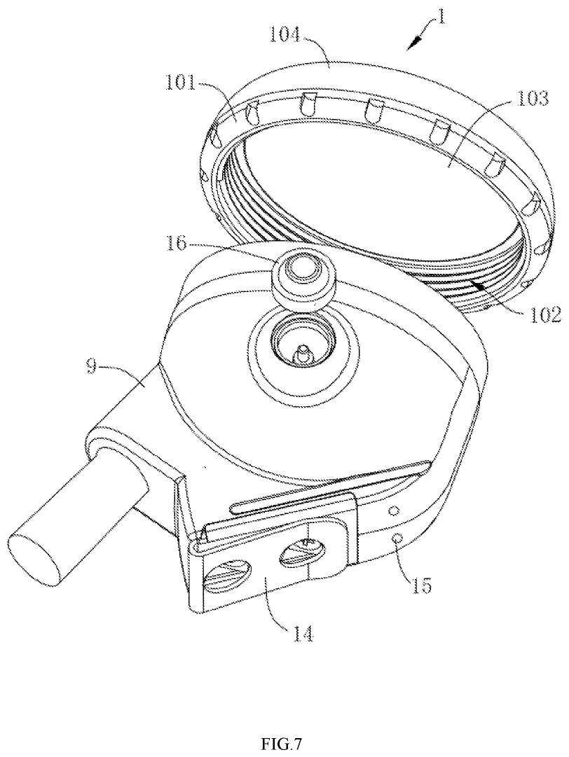

Referring to FIG. 1, FIG. 2, FIG. 6 and FIG. 7, FIG. 1 is a perspective view of an injection mold provided by an example of the application, FIG. 2 is a cross-sectional view of an injection mold provided by an example of the application, and FIG. 6 is a schematic diagram of an undercut portion provided by an example of the present application, and FIG. 7 is a schematic diagram of a miner lamp provided by an example of the present application.

As shown in FIG. 1, FIG. 2, FIG. 6 and FIG. 7, an example of the present application provides an injection mold, and the injection mold is used for molding a transparent plastic part 1, and the transparent plastic part 1 includes an undercut portion 101 and a flat portion 103. Optionally, in the present example, the transparent plastic part is a miner lamp, the undercut portion 101 is the lamp cover 901 of the miner lamp, and the inner undercut is formed on the inner wall of the lamp cover 901, and the flat portion 103 is the light-emitting lens 902 on the lamp cover 901. In the example, the inner undercut on the inner wall of the lamp cover 901 is an inner thread. The lamp cover 901 is installed on the lamp housing 9 of the miner lamp, so that the light emitted by the lighting assembly installed in the lamp cover 901 or the lamp housing 9 is emitted outward through the light-emitting lens 902, and the lamp cover 901 and the lamp housing 9 are opposite to the lamp cover 901 or the lamp housing 9. The lighting components and other electrical components inside play a protective role. The injection mold includes a fixed half 2, a moving half 3, a cavity 4, an insert 7, and a core 5. During operation, the fixed half 2 is fixedly installed in the injection molding machine (not shown in the figure), the movable mold 3 is installed in the injection molding machine, and the movable mold 3 is arranged facing fixed half 2. When the fixed half 2 and the moving half 3 are clamped, the first groove 401 provided in the fixed half 2 and the second groove 402 provided in the moving half 3 are arranged to face each other and communicate with each other to form a cavity 4. The first groove 401 and the second groove 402 are used for pouring molten and transparent molding material for molding the undercut portion 101 and the flat portion 103. It is understandable that there is also a rubber inlet connected to the first groove 401 on the fixed half 2.

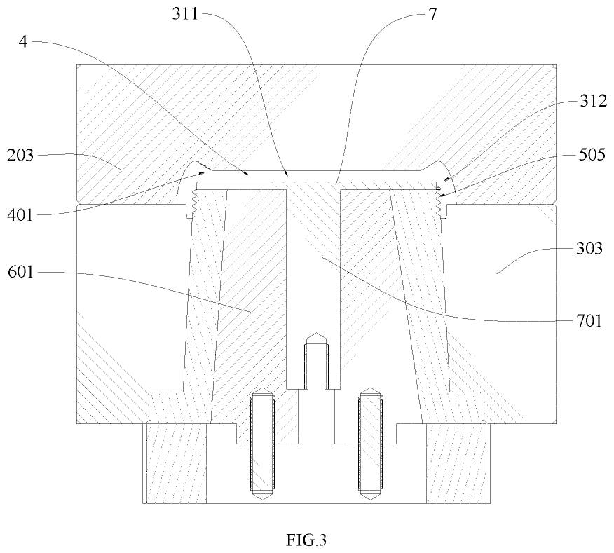

Referring to FIG. 3, the core 5 is partially embedded in the second groove 402 and connected to the moving half 3, the core 5 has a diameter variable end 505 whose diameter can be reduced or increased, and the end face of the diameter variable end 505 is provided with insert 7, and the diameter variable end 505 faces the fixed half 2 extends into cavity 4 and at least partially extends into the first groove 401. A first molding section 311 is formed between the insert 7 and the groove bottom of the first groove 401. The first molding section 311 is used for injection molding flat portion 103; a second molding section 312 is formed between the cavity walls, and the second molding section 312 is used for injection molding the undercut portion 101; the transparent molding material used to make the transparent flat portion 103 is carbonate polycarbonate, acrylonitrile-butadiene-styrene copolymer ABS, or thermoplastic plastic compounded by carbonate polycarbonate and acrylonitrile-butadiene-styrene copolymer ABS; in addition, colorless and transparent plexiglass, colored plexiglass, carbonate Polycarbonate and acrylonitrile-butadiene-styrene copolymer ABS can also be used for two-color injection molding according to requirements so as to form flat portion 103 of different colors and the transparent plastic part emit light of different colors, and the transparent plastic part can have good impact resistance and light transmittance, so as to meet the needs of use under different conditions.

The first molding section 311 and the second molding section 312 of the injection mold are filled with transparent and molten molding materials, the undercut portion 101 and the flat portion 103 of the transparent plastic part 1 are injection-molded. Further, in this embodiment, the diameter variable end 505 can extend into the cavity 4 in the direction of the fixed half 2, so part of the transparent molding material in the first molding section 311 and the second molding section 312 can be shaped, and the entire surface of the insert 7 abuts the flat portion 103, so that the occurrence of clamping lines on the flat portion 103 can be avoided. The injection mold in the application can integrally injection mold the undercut portion 101 and the flat portion 103 without assembling the flat portion 103 on the undercut portion 101, thereby improving the production and assembling efficiency of the transparent plastic part 1 and preventing the flat portion 103 from being pinched.

Referring to FIG. 2, in some specific examples, the fixed half 2 includes a first installation seat 201, a first installation position 202 and a first mold core 203, the first installation seat 201 is fixedly installed in the injection molding machine, and the first installation position 202 is arranged at the first installation seat 201 facing the moving half 3 at the end face, the first mold core 203 is installed in the first installation position 202, and the first groove 401 is installed in the first mold core 203 facing the moving half 3; the moving half 3 includes a second installation seat 301, a second installation position 302 and a second mold core 303, and the second installation seat 301 is movably installed in the injection molding machine, the second installation position 302 is located in the second installation seat 301 facing the fixed half 2, the second mold core 303 is installed in the second installation position 302, the second groove 402 is located in the second mold core 303 facing the first groove 401, and the second mold core 303 is also provided with an installation cavity 304 installed in the core 5 and connected to the second groove 402. The first mold core 203 and the second mold core 303 are precision parts, the first installation position 202 is the installation groove with the same shape as the first mold core 203, the second installation position 302 is the installation groove with the same shape as the second mold core 303, and the shape of the installation cavity 304 is the same as the shape of the core 5.

In some specific examples, the injection mold further includes a glue feeding system (not shown), the glue feeding system includes a rubber inlet and a glue feeding channel, the rubber inlet is arranged on the fixed half 2 or the moving half 3, and the glue feeding channel is used to connect the external space and the first groove 401 on the fixed half 2, or the second groove 402 on the movable mold 3 and the external space, the first groove 401 and the second groove 402 can be filled with transparent molding material through the glue feeding system, so that the transparent plastic part 1 is formed.

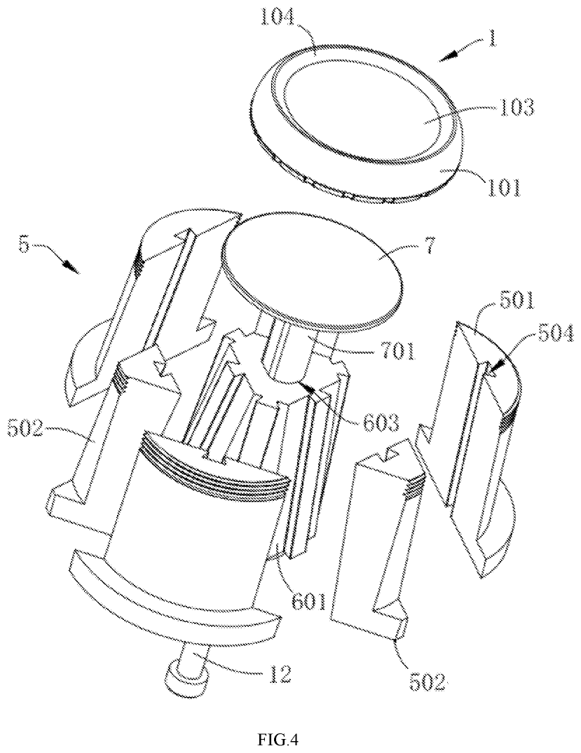

Referring to FIG. 4, FIG. 4 is an exploded view of the injection mold provided by the example of the present application.

Referring to FIG. 2 and FIG. 4, in the example of the present application, the injection mold further includes a demolding component 6, which is connected to the core 5, and the demolding component 6 is used to reduce the diameter of the diameter variable end 505 of the core 5, thereby separating the outer sidewall of the diameter variable end 505 from the inner sidewall of the undercut portion 102, which can achieve non-destructive demolding, ensure the yield, and the demolding process is convenient.

As shown in FIG. 2 and FIG. 3, in the example of the present application, the cross-sectional shape of the diameter variable end 505 of the core 5 is circular, and the cross-sectional area of the diameter variable end 505 is tapered in the direction of the moving half toward the fixed half. A portion of the outer sidewall of the diameter variable end 505 is provided with an outer inverted buckle to form an inner undercut on the inner sidewall of the undercut portion 101, thereby producing an undercut portion 101 with an inner undercut, so as to be connected to buckle's lamp housing 9 provided with the outer inverted buckle as shown in FIG. 7. which is convenient and of low manufacturing cost. It is worth mentioning that the undercut portion has a groove 102, and the flat portion 103 is located at the bottom of the groove 102. In this example, the inner undercut on the groove wall of groove 102 is an inner thread, and the outer inverted buckle on the undercut portion 101 is an outer thread. It is understood that the inner undercut and the outer inverted buckle are not provided in this example. In addition to the internal thread and the external thread, it is a right-angle undercut or a taper undercut.

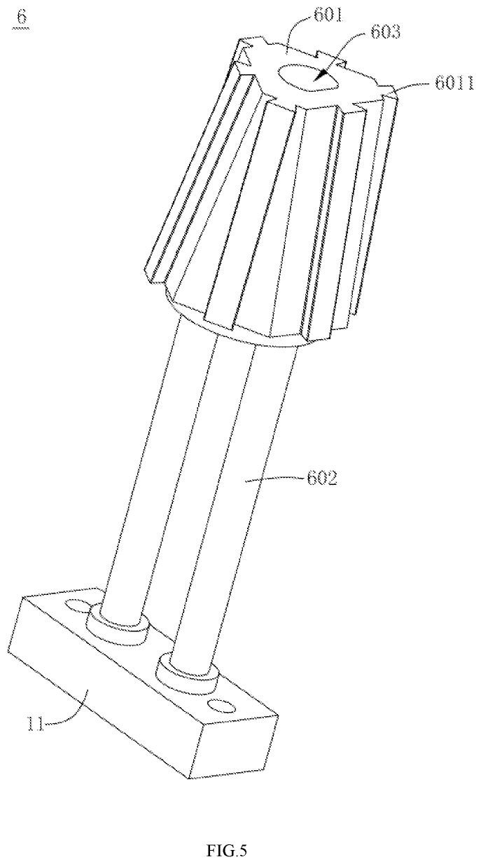

Referring to FIG. 5, FIG. 5 is a schematic diagram of the telescopic cone 601 according to an example of the present application. As shown in FIGS. 2 to 5, in the example of the present application, the core 5 includes a first slide 501 and a second slide 502, the outer sidewall of the first slide 501 and the outer sidewall of the second slide 502 are both arc-shaped walls, and the first slide 501 has a circumference and a plurality of intervals are arranged, and a second slide 502 is arranged between any two adjacent first slides 501, each first slide 501 and each second slide 502 are enclosed to form the cylindrical end of the core 5, the inner sidewall of each first slide 501 and the inner sidewall of each second slide 502 is enclosed to form an accommodating space 503. The demolding component 6 includes a telescopic cone 601, which is arranged in the accommodating space 503 and can slide along the axial direction of the core 5. When the telescopic cone 601 slides along the axis of the core in a direction away from fixed half 2, the each first slide 501 and each second slide 502 are synchronously retracted in the radial direction of the core 5, so that the outer sidewall of the diameter variable end 505 is separated from the groove wall of the groove 102. Specifically, the shape of the installation cavity 304 for installation of the core 5 is a truncated cone, the truncated installation cavity 304 has a large end and a small end with different radial dimensions, the small end of the installation cavity 304 faces the fixed half 2, and the large end of the installation cavity 304 deviates from the fixed half 2 and communicates with the external space, so that the core 5 can be loaded into the installation cavity 304 from the large end of the installation cavity 304, and the core 5 can form a frustum-shaped structure when being attached to the cavity wall of the installation cavity 304. It is understood that the telescopic cone 601 is a kind of the demolding tool, specifically, during demolding, the telescopic cone 601 slides along the axis of the core 5 in a direction away from the fixed half 2, and each first slide 501 and each second slide 502 are retracted in the radial direction of the core 5, thereby making the outer wall of the diameter variable end 505 is separated from the groove wall of groove 102, so that transparent plastic part 1 is separated from the core 5.

In this example, the telescopic cone 601 is a cone, and when the core 5 is attached to the cavity wall of the installation cavity 304, the shape of the accommodating space 503 is the same as that of the telescopic cone 601. The telescopic cone 601 has a large end and a small end with different radial dimensions. The small end faces fixed half 2, and the large end of the cone faces away from fixed half 2.

During injection molding, the telescopic cone 601 is fitted into the accommodating space 503 of the core 5, and the telescopic cone 601 presses the first slide 501 and the second slide 502 against the inner sidewall of the movable mold 3. When demolding, the telescopic cone 601 is moved in the direction away from the fixed half 2. The small end of the cone 601 can be gradually moved away from the fixed half 2, and each first slide 501 and each second slide 502 can be gradually retracted along the radial direction of the core 5, so that the outer sidewall of the diameter variable end 505 can be separated from the groove wall of the groove 102, and no damage can be achieved to ensure the yield, and the demolding process is convenient.

Further, as shown in FIG. 2 and FIG. 4, in this example, the core 5 includes a plurality of first slides 501 and a plurality of second slides 502, and the plurality of first slides 501 and the plurality of second slides 502 are staggered around the circumference. Specifically, the core 5 includes three first slides 501 and three second slides 502, four first slides 501 and four second slides 502, or other numbers of first slides 501 and second slides 502, which can be designed according to actual usage.

In some specific examples, as shown in FIGS. 4 and 5, the core 5 includes three first slides 501 and three second slides 502, a first included angle is formed between the first slide 501 and the center line of the telescopic cone 601, and. A second included angle is formed between the second slide 502 and the center line of the telescopic cone 601, and the first included angle is greater than the second included angle. Specifically, in this example, the angle between the first slide 501 and the center line of the telescopic cone 601 is 8°, the angle between the second slide 502 and the center line of the telescopic cone 601 is 4°. The inclination angles of the first slide 501 and the second slide 502 are all offset to the center line direction of telescopic cone 601, so that telescopic cone 601 can move 40 mm away from fixed half 2, first slide 501 can move 5.6 mm in the radial direction of the core 5, and the second slide 502 can move 2.8 mm in the radial direction of the core 5. When the mold is opened, the telescopic cone 601 moves at least 40 mm in the direction away from the fixed half 2, the relative movement between the telescopic cone 601 and the first slide 501 and the second slide 502 can ensure that the outer inverted buckle on the core 5 is smoothly separated from the inner undercut of the undercut portion 1. It should be noted that, for the undercut portion 1 of the inner undercut with different tooth pitches, the inclination angles of the first slide 501 and the second slide 502 are different, and the distance that the telescopic cone 601 needs to move is also different, as long as the smooth demolding of the product can be guaranteed, the specific parameters can be designed according to the specific product.

It can be understood that the core 5 is configured as an elastic member having the diameter variable end 505, such as a cylindrical elastic member, a circular frustum-shaped elastic member or other elastic members with cylindrical ends, and demolding component 6 is arranged to be extruded plates or other structures causing the cylindrical end of the core 5 to elastically deform.

Referring to FIG. 2, in some specific examples, the moving half 3 also includes a third installation position 305 and a limiter 306, the third installation position 305 is arranged on the bottom surface of the groove of second installation position 302, the limiter 306 is installed at third installation position 305, and is used to limit the core 5 away from the fixed half 2, the third installation position 305 is an installation groove with the same shape as the limiter 306; further, the limiter 306 is an annular piece, and the annular hole of the annular piece is larger than the large end of the telescopic cone 601 to prevent the interference of the telescopic cone 601 from sliding.

Referring to FIGS. 2 to 5, in the example of the present application, the first slide 501 and the second slide 502 are both provided with locating slots 504 arranged along the axis direction of the core 5, and the positions on telescopic cone 601 corresponding to each locating slot 504 are respectively provided with a limit block 6011 slidably connected to the corresponding locating slot 504.

In this example, through the cooperation of the locating slot 504 and the limit block 6011, the movement accuracy of the telescopic cone 601 is improved and the sliding resistance is reduced. In addition, the first slide 501 and the second slide 502 are prevented from rotating relative to the telescopic cone 601 in the circumferential direction. The inner undercut of the groove 102 is prevented from being damaged by the first slide 501 and the second slide 502 during demolding.

In other examples, the first slide 501 and the second slide 502 are respectively provided with limit blocks 6011 extending along the axis direction of the core 5, then the positions corresponding to the respective limit blocks 6011 on the telescopic cone 601 are respectively provided with the locating slot 504 slidably connected to the corresponding limit blocks 6011, thereby improving the movement accuracy of the telescopic cone 601 and reducing the sliding resistance; or, the first slide 501 and the second slide 502 are provided with a limit block 6011 arranged along the axis direction of the core 5, and the position on the telescopic cone 601 corresponding to each limit block 6011 is respectively provided with a locating slot 504 slidably connected to the corresponding limit block 6011, thereby further improving the movement accuracy of the telescopic cone 601 and reducing the sliding resistance; The positions corresponding to each limit block 6011 on the cone 601 are respectively provided with locating slots 504 slidably connected to the corresponding limit blocks 6011, the second slide 502 is provided with a locating slot 504 provided along the axis direction of the core 5, and the position on telescopic cone 601 corresponding to each locating slot 504 is provided with limit blocks 6011 slidably connected to the corresponding locating slots 504.

It is understood that the specific positions of the limit block 6011 and the locating slot 504 are arranged on the first slide 501, the second slide 502 and the telescopic cone 601 do not affect the realization of the concept of the present application. As long as the locating slot 504 and the limit block 6011 can cooperate, the movement accuracy of the telescopic cone 601 can be improved and the sliding resistance can be reduced. In addition, the first slide 501 and the second slide 502 can be prevented from rotating relative to the telescopic cone 601 in the circumferential direction. The first slide 501 and the second slide 502 are driven by the axial movement of the telescopic cone 601 to achieve lateral movement so as to prevent the first slide 501 and the second slide 502 from causing damage to the inner undercut of the groove wall of the groove 102 during demolding, and achieve the effect of smooth demolding of the undercut portion 1. Optionally, in this example, the locating slot 504 is a dovetail slot, and the shape of the limit block 6011 is adapted to the dovetail slot, so that the circumferential rotation of the limit block 6011 along the telescopic cone 601 can be prevented.

Referring to FIG. 2, in the example of the present application, the injection mold further includes a drive assembly 10 connected to the telescopic cone 601, and the drive assembly 10 is used to drive the telescopic cone 601 to slide along the axis of the core 5, thereby enabling the outer wall of the diameter variable end 505 separated from the groove wall of groove 102, which can achieve non-destructive demolding and ensure the yield.

Furthermore, as shown in FIG. 2, in this example, the drive assembly 10 includes a first connection board 1001 and a driver (not shown in the figure), and the driver is installed in the injection molding machine. The demolding component 6 also includes a first connector 602. The first end of the first connector 602 is connected to the telescopic cone 601, the second end of the first connector 602 is connected to the first connection board 1001, the driving end of the driver is used to connect to the first connection board 1001, and to drive the first connection board 1001 to move in the direction away from the fixed half 2, thereby driving the first connector 602 and the telescopic cone 601 to move in the direction away from the fixed half 2, and the first slide 501 and the second slide 502 are gradually retracted along the radial direction of the core 5, so that the outer wall of the diameter variable end 505 is separated from the groove wall of the groove 102, and non-destructive demolding is achieved. The yield is guaranteed, and the demolding process is convenient. The driving member is arranged as a linear motor, a driving cylinder or other driving members, and the first connector 602 is arranged as a connecting rod, a double-ended screw or other connecting members.

Furthermore, as shown in FIG. 2, in this example, the demolding component 6 includes a pair of first connectors 602 arranged in parallel, the first ends of each first connector 602 are connected to the telescopic cone 601, and the second ends of the pair of first connectors 602 are connected to the second connection board 11, a pair of first connectors 602 are connected to the first connection board 1001 through the second connection board 11, and the telescopic cone 601 and the first connection board 1001 can realize multi-point connection through the pair of first connectors 602, which can improve the connection stability. The second connection board 11 and the first connection board 1001 are connected by a plurality of screws.

Referring to FIG. 2 and FIG. 3, in the example of the present application, the surface of insert 7 facing the fixed half 2 is a smooth plane, and the bottom surface of the groove of the first groove 401 is a smooth plane to form a flat portion 103 with a flat surface between the bottom surface of the groove of the first groove 401 and the insert 7. The insert 7 is specifically arranged as a circular flat plate, and preferably, the area of the circular flat plate is equal to the area of the flat portion 103.

Since the core 5 is formed by splicing and enclosing a plurality of first slides 501 and a plurality of second slides 502, and a telescopic cone 601 is also provided in the accommodating space 503 of the core 5, when the undercut portion 1 is produced by injection molding, the contour lines of the diameter variable end 505 and the telescopic cone 601 facing one end of the fixed half 2 will cause disordered lines to be formed on the bottom surface of the groove 102, thereby affecting the flatness of the formed flat portion 103 and the light extraction performance of the flat portion 103. In this example, the insert 7 with a smooth plane is arranged on the end face of the diameter variable end 505, so that the diameter variable end 505 of the core 5 and the end of the telescopic cone 601 facing the fixed half 2 can be isolated from the flat portion 103, and the inner bottom surface of the groove of the first groove 401 is a smooth plane, the formation of cluttered lines on the flat portion 103 can be prevented, thereby ensuring the flatness of the flat portion 103 and improving the light extraction performance of the flat portion 103.

Furthermore, as shown in FIG. 2 and FIG. 4, a rod 701 is protruded from the side of the insert 7 away from the fixed half 2, and the injection mold also includes a second connector 12. The telescopic cone 601 is provided with a through hole 603 arranged along the axial direction of the core 5, and the second connector 12 penetrates through the through hole 603, the first end of the second connector 12 is connected to the rod 701 of the insert 7, and the second end of the second connector 12 is connected to the end of the moving half 3 away from the fixed half 2. The second connector 12 can be arranged as a double-ended screw, a plug screw or other connecting piece, and the second end of the second connector 12 is connected to the second installation seat 301.

In this example, the insert 7 is fixedly installed on the moving half 3 through the rod 701 and the second connector 12. When the undercut portion 1 is produced by injection molding, the displacement of the insert 7 can be prevented, and the flatness of the flat portion 103 and the light output performance of the flat portion 103 can be avoided.

Referring to FIG. 2, in the example of the present application, the end surface of the diameter variable end 505 is a smooth plane (not shown), and the bottom surface of the groove of the first groove 401 is a smooth plane, so that the bottom surface of the groove of the first groove 401 and the bottom surface of the core 5 are smooth. A flat portion 103 with a flat surface is formed between the diameter variable ends 505. The core 5 is arranged as an elastic integral structure, and the demolding component 6 is arranged as a pressing plate or other structure that can induce elastic deformation of the core 5.

In this example, the end surface of the diameter variable end 505 forms a smooth plane, and the inner bottom surface of the first groove 401 is a smooth plane, which can prevent the formation of cluttered lines on the flat portion 103, thereby ensuring the flatness of the flat portion 103 and improving light output performance the flat portion 103. In addition, the core 5 in this example has the advantage of a simple structure. It can be understood that the smooth plane refers to the surface roughness of the plane is relatively low, optionally, the roughness of the smooth plane in this example ranges from 0.01 to 0.08.

Referring to FIG. 2, in the example of the present application, the injection mold further includes an ejection component 8, and the ejection component 8 is slidably disposed in the moving half 3. In the actual use process, after demolding is completed and the fixed half 2 and the moving half 3 are separated, the ejection component 8 slides in the moving half 3, the end of the ejection component 8 facing the fixed half 2 can push the undercut portion 1 in the second groove 402 out to the outside space, which is easy to operate.

Referring to FIG. 2, in the example of the present application, the cavity 4 further includes an annual groove 403 that communicates with the first groove 401, the annular groove 403 is provided on the inner bottom surface of the first groove 401, and the annular groove 403 is used for pouring a transparent molding material, so that the flat portion 103 can be filled with a transparent molding material. The outer edge of the transparent plastic part is injection-molded with the annular boss 104 protruding in the direction away from the groove 102 to form an anti-collision structure, which can protect the flat portion 103 and reduce wear on the flat portion 103, when the transparent plastic part is bumped.

Referring to FIG. 2, in some specific examples, the fixed half 2 and the moving half 3 are locked by a locking component 13. Specifically, the locking component 13 may be a wheel-type mold locking structure or other locking components. When the undercut portion 101 is produced by injection molding, the fixed half 2 and the moving half 3 are locked by the locking component 13, which can prevent the fixed half 2 and the moving half 3 from being separated, thereby ensuring the normal operation of the injection mold.

Referring to FIG. 6, an example of the present application provides a transparent plastic part 1, which is integrally injection-molded by the injection mold in the above-mentioned example. The transparent plastic part 1 includes an undercut portion 1 and a flat portion 103 connected to the undercut portion 101. The undercut portion 101 is provided with a groove 102, the flat portion 103 is arranged at the bottom of the groove 102.

In this example, the undercut portion 101 has a flat portion 103 integrally injection-molded with the undercut portion 101, so that it is unnecessary to assemble the flat portion 103 on the undercut portion 101 separately, thereby improving the production and assembly efficiency of the transparent plastic part.

Referring to FIG. 7, an example of the present application provides a miner lamp, which includes the transparent plastic part 1 in the above example.

Referring to FIG. 6, when manufacturing the miner lamp in this example, it is no longer necessary to separately manufacture the light-emitting lens 902 and the lamp cover 901 with the light outlet, and then assemble the light-emitting lens 902 on the light outlet on the lamp cover 901. Instead, the above-mentioned injection mold can be integrally injection-molded, including the lamp cover 901 and the light-emitting lens 902, thereby improving the production and assembly efficiency of the miner lamp.

Further, as shown in FIG. 7, in this example, the miner lamp further includes a lamp housing 9 and a lighting assembly (not shown), the undercut portion 101 is detachably installed on the lamp housing 9, and the lighting assembly is arranged in the installation space formed between the undercut portion 101 and the lamp housing 9, the undercut portion 101 and the lamp housing 9 can protect the lighting assembly.

The example of the present application also provides an injection molding method, which includes the following steps:
S1: preparing the injection mold;
S2: injecting, melting transparent molding material, and injecting the molten molding material into the first molding section and the second molding section through the glue inlet;
S3: holding pressure, maintaining the fixed half and the moving half for a predetermined time to integrally form the undercut portion and the flat portion;
S4: demolding, separating the fixed half and the movable mold, and taking out the undercut portion and the flat portion.

Furthermore, S4 demolding also includes the following steps:
S41: the telescopic core slides a predetermined distance along the central axis of the core and away from the direction of the fixed half;
S42: each of the first slides and each of the second slides are inwardly retracted along the radial direction of the core under a driving of the telescopic cone;
S43: the outer wall of the diameter variable end is separated from the undercut portion.

The above are only preferred examples of the present application and are not intended to limit the present application. Any modifications, equivalent replacements and improvements made within the spirit and principles of the present application shall be included in the protection scope of the present application.

What is claimed is:

1. An injection mold, configured for injection molding a transparent plastic part comprising an undercut portion and a flat portion connected to the undercut portion, and the injection mold comprising:
an insert;
a fixed half, having a first groove and a rubber inlet communicating with the first groove;
a moving half, configured for matching with the fixed half, the moving half having a second groove, and the fixed half and the moving half being stacked to form a cavity together by the first groove communicating with the second groove; and
a core, wherein the core is partially embedded in the second groove and connected to the moving half, the core has a diameter variable end at least partially located in the cavity, the diameter of the diameter variable end is variable, and the insert is arranged on an end face of the diameter variable end, a first molding section is formed between the insert and a bottom of the first groove, the first molding section is configured for injection molding the flat portion; a second molding section is formed between an outer wall of the diameter variable end and a cavity wall of the corresponding cavity, the second molding section is configured for injection molding the undercut portion; and the first molding section communicates with the second molding section to integrally form the flat portion and the undercut portion.

2. The injection mold according to claim 1, further comprising a demolding component, wherein
the demolding component is connected to the core, the demolding component is configured to reduce the diameter of the diameter variable end to separate the outer sidewall of the diameter variable end from the inner sidewall of the undercut portion.

3. The injection mold according to claim 2, wherein a cross-sectional shape of the diameter variable end is a circle, and the outer wall of the diameter variable end is provided with an outer inverted buckle to form an inner undercut on the inner side wall of the undercut portion.

4. The injection mold according to claim 3, wherein
the core comprises: a plurality of first slides and a plurality of second slides; the plurality of the first slides are circumferentially arranged at intervals and each of the plurality of second slides is arranged between every two adjacent first slides; the outer sidewall of each of the plurality of first slide and the outer sidewall of each of the plurality of second slides are arc-shaped walls; the plurality of first slides and the plurality of second slides are enclosed to form the diameter variable end; and inner sidewalls of the plurality of first slides and inner side walls of the plurality of second slides are enclosed to form an accommodating space; and
the demolding component comprises a telescopic cone, the telescopic cone is arranged in the accommodating space and slidable along an axial direction of the core; and in a slidable state along the axis of the core in a direction away from the fixed half, the telescopic cone is configured to drive the plurality of first slides and the plurality of the second slides to radially and inwardly retract synchronously along the core to separate the outer wall of the diameter variable end from the inner sidewall of the undercut portion.

5. The injection mold according to claim 4, wherein each of the plurality of first slides and each of the plurality of second slides are both provided with locating slots arranged along the axial direction of the core, and a position of the telescopic cone corresponding to each of the plurality of locating slots is respectively provided with a limit block slidably connected to a corresponding locating slot.

6. The injection mold according to claim 5, wherein a first included angle is formed between each of the plurality of first slides and a center line of the telescopic cone; a second included angle is formed between each of the plurality of second slides and the center line of the telescopic cone; and the first included angle is twice the second included angle.

7. The injection mold according to claim 1, wherein a surface of the insert facing the fixed half is a smooth plane to form the flat portion with a flat inner surface between the inner bottom surface of the first groove and the insert.

8. The injection mold according to claim 2, wherein a surface of the insert facing the fixed half is a smooth plane to form the flat portion with a flat inner surface between the inner bottom surface of the first groove and the insert.

9. The injection mold according to claim 3, wherein a surface of the insert facing the fixed half is a smooth plane to form the flat portion with a flat inner surface between the inner bottom surface of the first groove and the insert.

10. The injection mold according to claim 4, wherein a surface of the insert facing the fixed half is a smooth plane to form the flat portion with a flat inner surface between the inner bottom surface of the first groove and the insert.

11. The injection mold according to claim 5, wherein a surface of the insert facing the fixed half is a smooth plane to form the flat portion with a flat inner surface between the inner bottom surface of the first groove and the insert.

12. The injection mold according to claim 6, wherein a surface of the insert facing the fixed half is a smooth plane to form the flat portion with a flat inner surface between the inner bottom surface of the first groove and the insert.

13. A transparent plastic part, integrally injection molded by an injection mold, and comprising an undercut portion and a flat portion integrally formed with the undercut portion,
wherein
a groove is formed in the undercut portion, and an inner bottom surface of the groove forms the flat portion;
the injection mold comprises:
an insert;
a fixed half, having a first groove and a rubber inlet communicating with the first groove;
a moving half, configured for matching with the fixed half, the moving half having a second groove, and the fixed half and the moving half being stacked to form a cavity together by the first groove communicating with the second groove; and
a core, wherein the core is partially embedded in the second groove and connected to the moving half, the core has a diameter variable end at least partially located in the cavity, the diameter of the diameter variable end is variable, and the insert is arranged on an end face of the diameter variable end, a first molding section is formed between the insert and a bottom of the first groove, the first molding section is configured for injection molding the flat portion; a second molding section is formed between an outer wall of the diameter variable end and a cavity wall of the corresponding cavity, the second molding section is configured for injection molding the undercut portion; and the first molding section communicates with the second molding section to integrally form the flat portion and the undercut portion.

14. The transparent plastic part according to claim 13, further comprising a demolding component, wherein
the demolding component is connected to the core, the demolding component is configured to reduce the diameter of the diameter variable end to separate the outer sidewall of the diameter variable end from the inner sidewall of the undercut portion.

15. The transparent plastic part according to claim 14, wherein a cross-sectional shape of the diameter variable end is a circle, and the outer wall of the diameter variable end is provided with an outer inverted buckle to form an inner undercut on the inner side wall of the undercut portion.

16. The transparent plastic part according to claim 15, wherein
the core comprises: a plurality of first slides and a plurality of second slides; the plurality of the first slides are circumferentially arranged at intervals and each of the plurality of second slides is arranged between every two adjacent first slides; the outer sidewall of each of the plurality of first slide and the outer sidewall of each of the plurality of second slides are arc-shaped walls; the plurality of first slides and the plurality of second slides are enclosed to form the diameter variable end; and inner sidewalls of the plurality of first slides and inner side walls of the plurality of second slides are enclosed to form an accommodating space; and
the demolding component comprises a telescopic cone, the telescopic cone is arranged in the accommodating space and slidable along an axial direction of the core; and in a slidable state along the axis of the core in a direction away from the fixed half, the telescopic cone is configured to drive the plurality of first slides and the plurality of the second slides to radially and inwardly retract synchronously along the core to separate the outer wall of the diameter variable end from the inner sidewall of the undercut portion.

17. The transparent plastic part according to claim 16, wherein each of the plurality of first slides and each of the plurality of second slides are both provided with locating slots arranged along the axial direction of the core, and a position of the telescopic cone corresponding to each of the plurality of locating slots is respectively provided with a limit block slidably connected to a corresponding locating slot.

18. The transparent plastic part according to claim 17, wherein a first included angle is formed between each of the plurality of first slides and a center line of the telescopic cone; a second included angle is formed between each of the plurality of second slides and the center line of the telescopic cone; and the first included angle is twice the second included angle.

19. A method of injection molding, comprising steps of:
preparing the injection mold according to claim 4;
injecting, comprising: melting transparent molding material, and injecting the molten molding material into the first molding section and the second molding section through the glue inlet;
holding pressure, comprising: maintaining the fixed half and the moving half for a predetermined time to integrally form the undercut portion and the flat portion; and
demolding, comprising: separating the fixed half and the moving half, and taking out the undercut portion and the flat portion.

20. The method of injection molding according to claim 19, further comprising steps of:
sliding a predetermined distance along the central axis of the core and away from the direction of the fixed half by the telescopic core;
retracting each of the plurality of the first slides and each of the plurality of the second slides inwardly along the radial direction of the core under a driving of the telescopic cone;
separating the outer wall of the diameter variable end from the undercut portion.
